(19) United States
(12) Patent Application Publication
(10) Pub. No.: US 2013/0027927 A1
(43) Pub. Date: Jan. 31, 2013

(54) FLOATING LIGHT LUMINAIRE

(71) Applicants: Emil Wegger, Viby J. (DK); Markus J. Mayer, Munich (DE); Fabio Reyes, Silkeborg (DE); Claus Jepsen, Horsens (DK); Nick Ross, San Francisco, CA (US)

(72) Inventors: Emil Wegger, Viby J. (DK); Markus J. Mayer, Munich (DE); Fabio Reyes, Silkeborg (DE); Claus Jepsen, Horsens (DK); Nick Ross, San Francisco, CA (US)

(21) Appl. No.: 13/368,879

(22) Filed: Feb. 8, 2012

Related U.S. Application Data
(60) Provisional application No. 61/440,756, filed on Feb. 8, 2011.

(51) Int. Cl. F21V 8/00

(52) U.S. Cl. 362/235

(57) ABSTRACT

A luminaire comprising a waveguide having one or more sides and a frame. The frame includes at least one light module configured to direct light into the one or more sides of the waveguide. The waveguide includes a light emitting region at least substantially surrounded by a non-light emitting region.

This application claims priority to U.S. provisional Ser. No. 61/440,756 filed Feb. 8, 2011, the disclosure of which is hereby incorporated by reference.

### BACKGROUND

The present exemplary embodiment relates to a luminaire. It finds particular application in conjunction with a luminaire for general illumination in which the appearance of a floating light is desirable, and will be described with particular reference thereto. However, it is to be appreciated that the present exemplary embodiment is also amenable to other like applications.

A lighting fixture commonly found in offices and commercial premises is a fluorescent lighting panel. Generally, such lighting panels comprise an enclosure housing one or more fluorescent tubes and a front diffusing panel. Typically, the diffusing panel is a translucent plastic material or a light transmissive plastic material with a regular surface patterning to promote a uniform light emission. Alternatively, a light reflective louvered front cover can be used to diffuse the emitted light. Such lighting panels are often intended for use in a suspended (drop) ceiling in which a grid of support members (T bars) are suspended from the ceiling by cables and ceiling tiles supported by the grid of support members. The ceiling tiles can be square or rectangular in shape and the lighting panel module is configured to fit within such openings with the diffusing panel replacing the ceiling tile.

Due to their long operating life expectancy (of order 30-50,000 hours) and high luminous efficacy (70 lumens per watt and higher) high brightness white LEDs are increasingly being used to replace conventional fluorescent, compact fluorescent and incandescent bulbs. Today, most lighting fixture designs utilizing white LEDs comprise systems in which a white LED (more typically an array of white LEDs) replaces the conventional light source component. Moreover, due to their compact size, compared with conventional light sources, white LEDs offer the potential to construct novel and compact lighting fixtures.

Edge-lit lighting panel lamps are also known in which light is coupled into the edges of a planar light guiding panel (waveguiding medium). The light is guided by total internal reflection throughout the volume of the medium and then emitted from a light emitting face. To reduce light emission from the rear face of the panel (i.e. the face opposite the light emitting face), the rear face will often include a light reflective layer. To encourage a uniform emission of light, one or both faces of the light guiding panel can include a surface patterning such as a hexagonal or square array of circular areas. Each area comprises a surface roughening and causes a disruption to the light guiding properties of the light guiding panel at the site of the area resulting in a preferential emission of light at the area. An advantage of an edge-lit lighting panel lamp compared with a back-lit panel lamp is its compact nature, especially overall depth (thickness) of the lamp which can be comparable with the thickness of the light guiding panel making it possible to construct a lamp of less than 50 mm in depth.

### BRIEF DISCLOSURE

According to a first embodiment, a luminaire is provided comprising a waveguide having one or more sides and a frame. The frame includes at least one light module configured to direct light into the one or more sides of the waveguide. The waveguide includes a light emitting region and non-light emitting region disposed between the frame and the light emitting region.

According to a further embodiment, a luminaire comprising a waveguide having at least three sidewalls and two opposed planar surfaces is provided. A frame is secured to the sidewalls. The frame includes at least one light module configured to direct light into the waveguide. At least one of the planar surfaces of the waveguide includes a light emitting region. An at least substantially transparent non-light emitting region is disposed between the frame and the light emitting region.

According to another embodiment, a luminaire comprising a waveguide having a sidewall and at least one planar surface is provided. A frame is secured to sidewall. The frame includes at least one light module configured to direct light into the waveguide, wherein only the planar surface of the waveguide has a light emitting region. Furthermore, an at least substantially transparent non-light emitting region is disposed between the frame and the light emitting region.

### BRIEF DESCRIPTION OF THE DRAWINGS

FIG. 1 illustrates a perspective view of a rectangular floating light luminaire in accordance with one aspect of the present disclosure;

FIG. 2 illustrates a perspective view of a square floating light luminaire in accordance with another aspect of the present disclosure;

FIG. 3 illustrates a bottom perspective view of the square floating light luminaire of FIG. 2;

FIG. 4 illustrates a bottom perspective view of a circular floating light luminaire in accordance with yet another aspect of the present disclosure;

FIG. 5 illustrates a stand version of a floating light in accordance with another aspect of the present disclosure

FIG. 6 illustrates a floating light having a light pattern in accordance with yet another aspect of the present disclosure; and

FIG. 7 illustrates a dimmer control and backlit logo in accordance with still another aspect of the present disclosure.

### DETAILED DESCRIPTION

The present disclosure is directed to luminaries having the appearance of a “floating light”. The floating light luminaire provides a thin profile luminaire where the light is emitted from the large surfaces of a transparent or semi-transparent material called a waveguide.

The waveguide is surrounded by a frame that houses at least one light source module, which is configured to direct light into one or multiple sides of the waveguide, allowing light to enter the waveguide and fill at least a portion of volume of the waveguide. The frame may surround all edges of the waveguide or may encompass as few as one edge. The light source is preferably hidden within the light source module, such that it is not visible to an observer, and is directed into the edge of the waveguide. The frame, including the light source module(s), provides structure to the luminaire, integrates the light source module(s) and provides an attachment point for the luminaire support mechanism.

The luminaire may be attached according to a variety of mounting techniques, including being suspended from the ceiling or fixed on a stand, wall or other support structure. The dimensions of the luminaire depend on the application, but can have a thickness of less than 50 mm. The waveguide thickness is generally smaller compared to any of the other dimensions of the luminaire.

The term waveguide refers to a piece of transparent or semi-transparent material that guides the light through total internal reflection. The light tends to fill the whole volume of the waveguide. Once the light enters the waveguide, the light will travel until it hits a surface having an angle greater than a critical angle over which the light is not reflected. If the angle of the surface is inferior to the critical angle, the light will be reflected back into the waveguide. The waveguide may include features created on the surface and/or within the waveguide designed to capture the light traveling into the waveguide and extract it, by causing the angle of the surface to be greater than the critical angle. These features may be used to direct the light out of the waveguide in a diffuse manner or at angle from the waveguide surfaces. This feature can allow the present luminaire to function for general illumination or to direct light onto a surface or object such as a wall, shelve, counter top or a display, etc. In areas of the waveguide that do not include the features for redirecting light to exit the waveguide, zones are created where light remains in the waveguide. Such zones appear as “dark zones” with no light emission.

Laser etching, chemical etching and shape painting are currently used as diffuse light extraction methods. Alternatively, microlens light distribution features can be used and can be varied by size, shape, density and location to accommodate custom light input and output requirements. The microlens features and pattern in the waveguide or a film secured to the waveguide surface can be customized to efficiently spread the light across the entire lighting surface or focus it in specific locations depending on the application and illumination requirements. Microlens features enable the control of uniformity, exit angle and spread of the light, and can be implemented through a highly repeatable patterning process, enabling high-volume, custom-designed light guides and films. Microlens light distribution features take advantage of highly-efficient specular reflection, versus the diffuse reflection of competing technologies to provide optimum light delivery for edge-lit LED-based lighting fixtures.

According to one embodiment, the waveguide creates the aesthetic impression of a floating light, by creating a “dark zone” region between the light source and/or the frame and the region configured to emit light. Moreover, the dark zone is a region where no light is emitted. The dark zone can be opaque, translucent or transparent.

A transparent/translucent dark zone region advantageously provides the luminaire with the appearance of a light floating distinct of its frame elements.

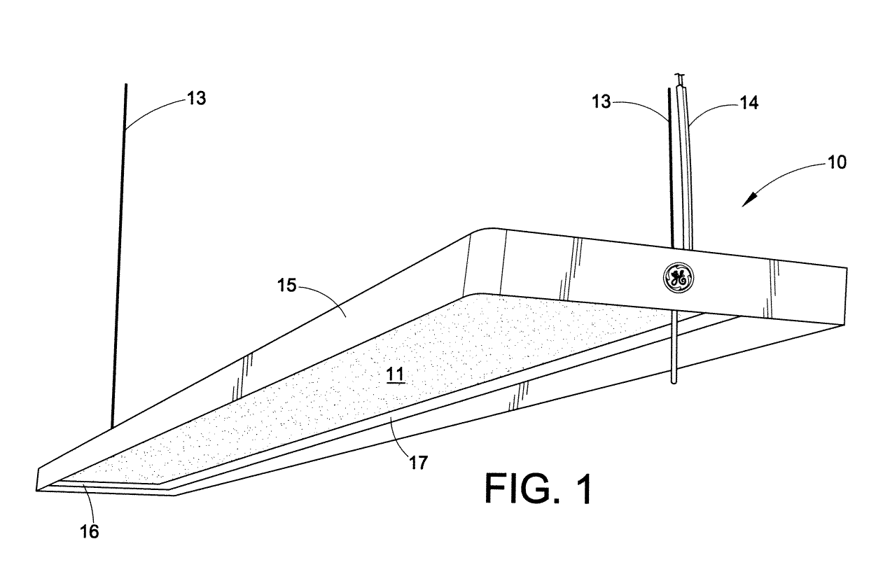

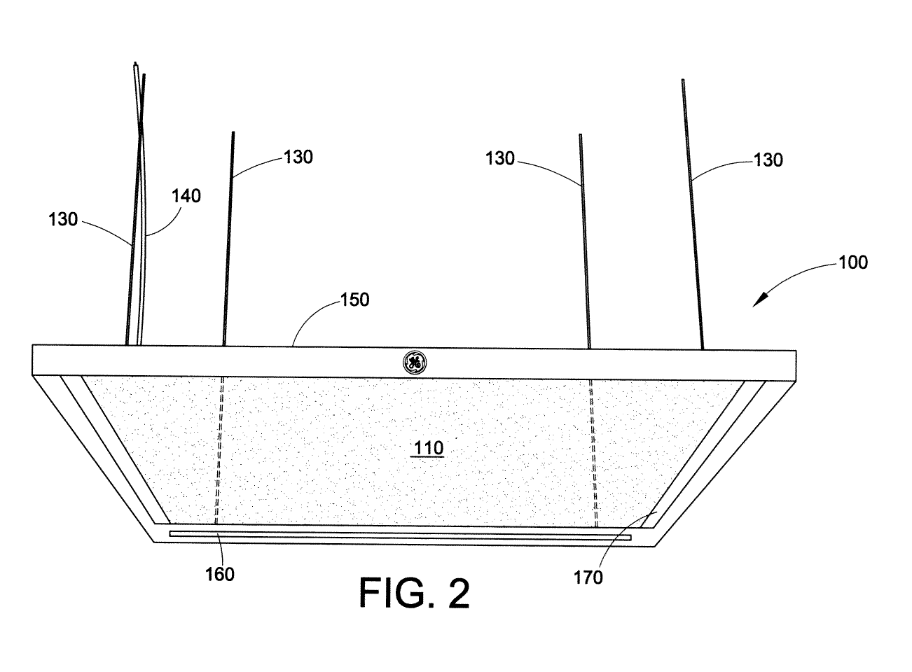

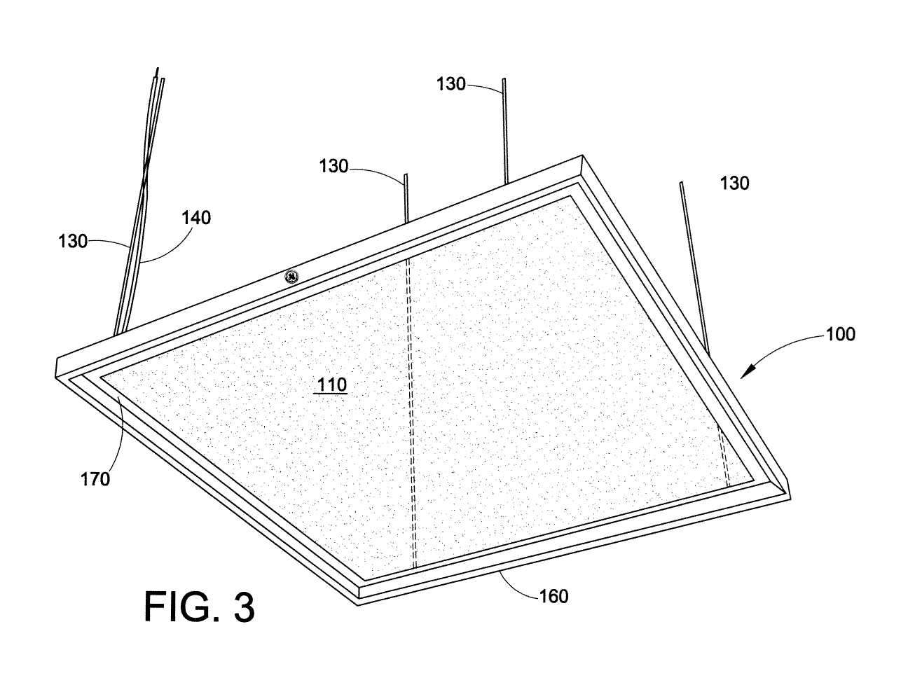

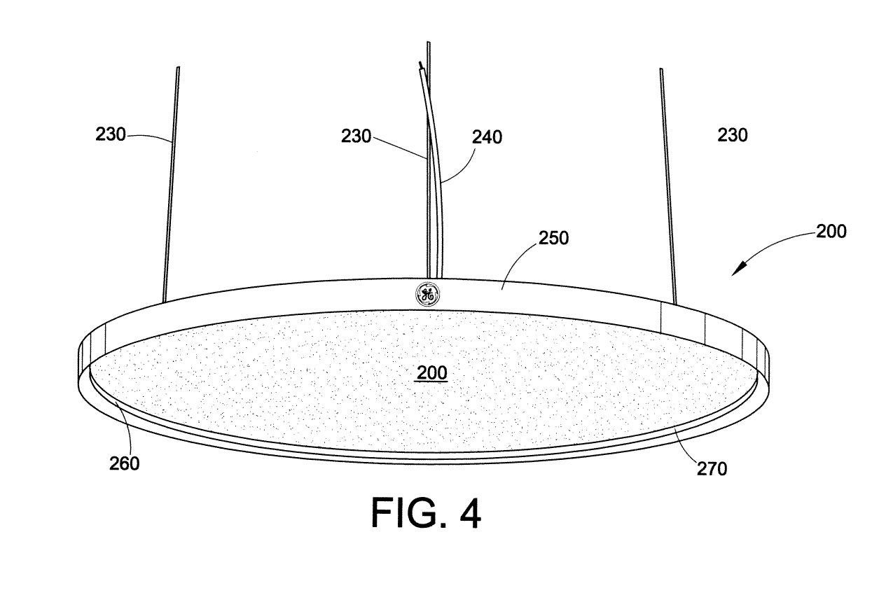

With reference to FIGS. 1-4, various floating light luminaire (10, 100, 200) are provided wherein the waveguide (11, 110, 210) and frame assemblies (12, 120, 220) take on a variety of shapes, including a rectangle (10), square (100), and circle (200). Although the Figures illustrate the waveguide/frame assembly as being rectangular, square and circular, the waveguide/frame assembly may comprise any shape desired for a particular application.

Each of luminaire (10, 100, 200) are depicted as suspended devices including suspension wires (13, 130, 230) and a power cord (14, 140, 240). The suspension wires (13, 130, 230) are secured to a frame (15, 150, 250). Each frame (15, 150, 250) is shaped cooperatively to the shape of the waveguides (11, 110, 210). The frame (15, 150, 250) further serves as the location in which a light emitting module (16, 160, 260) and electronics (not shown) for properly converting AC current received from the power cord (14, 140, 240) are disposed.

The light emitting module can be composed of one or more light emitting diodes (LED's) oriented to direct light into the edge of the waveguide (11, 110, 210). Typically, a single light emitting module will be sufficient. However, for particularly large or complexly shaped waveguides, multiple light emitting modules may be desirable.

Each waveguide (11, 110, 210) is designed to provide a dark zone region (17, 170, 270) adjacent its outer edge and the frame (12, 120, 220) in which light is not directed out of the waveguide. In one embodiment, when the dark zone region is transparent, as stated earlier, an impression that the light is floating in air is created.

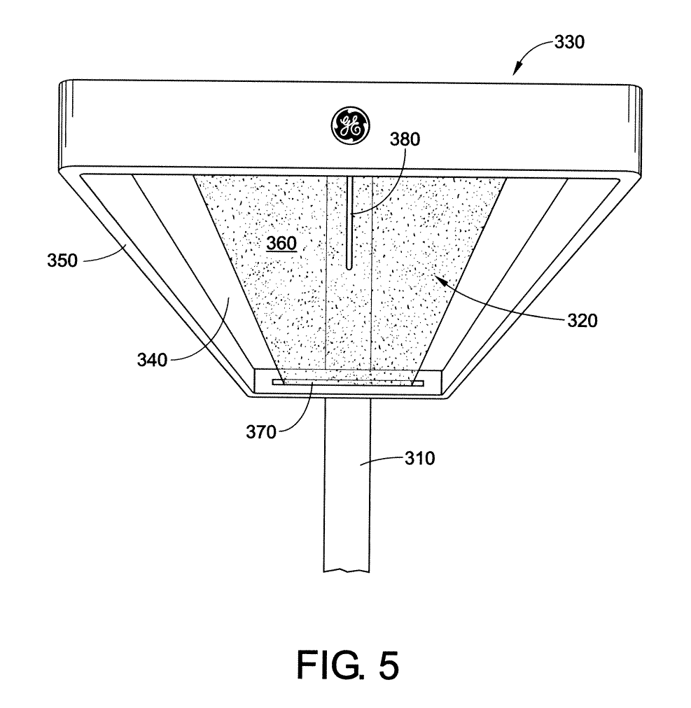

As illustrated in FIG. 5, a luminaire (300) is provided that includes a support mount (310) for securing to a wall, stand or ceiling. The waveguide can emit light from each major planar surface (320, 330) or only one. The waveguide includes a non-light emitting region (340) between the frame (350) and the light emitting region (360), such that the luminaire, when lit by light emitting module (370), appears to be floating. As mentioned above, this non-light emitting region is created by providing only the center of the waveguide with the necessary reflective features to ensure light is reflected at an angle greater than the critical angle, which allows the light to be redirected to the exterior of the waveguide. The non-light emitting zone (340), however, remains without such features and the light in this region remains within the waveguide. A dimmer switch (380) is provided as a component of the frame (350).

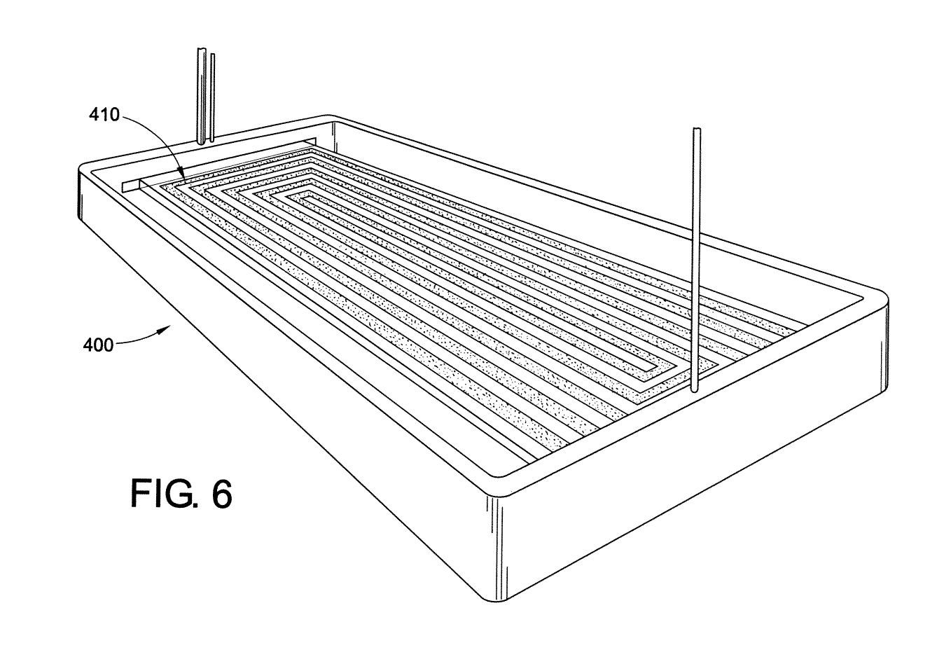

FIG. 6 illustrates a floating light luminaire (400) that includes dark zone regions throughout the waveguide to create a light emission pattern (410). The pattern may comprise shapes, designs, numbers, words, etc., depending on the desired application. The intensity of light emitted within the light emitting region can be fixed or variable. Similarly, it is envisioned that the light emitting region can vary in intensity such that brighter zones can exist. Furthermore, it is envisioned that light may be emitted diffusely or may be directed within a limited angle of distribution.

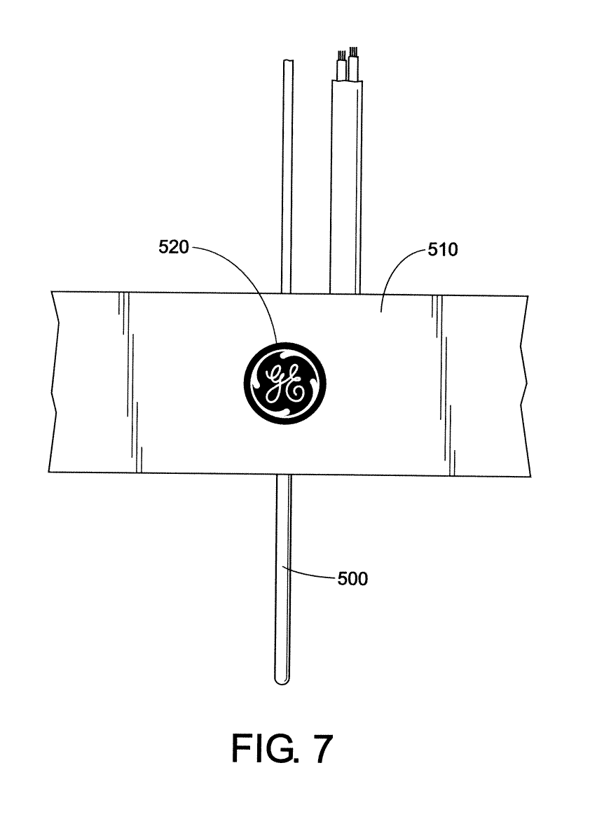

FIG. 7 illustrates a dimmer control (500) for controlling the intensity of light. The optional dimming control is integrated into the unit's frame (510) and allows a user to manually adjust the intensity of the luminaire. The dimming control may take the form of a rod (any shape) attached to a resistive or capacitive potentiometer measuring the amplitude of the movement of the control arm and angular movement in the axis of the rod or the angular movement of one end of the rod. The integration of the potentiometer doesn't exclude the possibility of controlling the light output of the luminaire using a centralized dimming control. Additionally, a backlit logo (520) may be incorporated.

This application provides the design appearance of luminaries having a floating light, which can be described as using transparency or translucency to create an impression of floating light which is disconnected from the luminaire frame. The floating light concept refers to the ability to create a zone between the light source and zone emitting light where no light is emitted. Another advantage of the floating light concept is the hiding of the light source so it is not directly visible by the user. This creates the illusion of a floating light coming out of nowhere.

Other parameters included in this application are 1) the integration of frames around the luminaries' light emission zone to emphasize the illusion of floating light. The frames provide structure to the luminaire and they serve to integrate the light sources and provide attachment points for the waveguide and the luminaire being suspended or supported using flexible or rigid elements, 2) the optional integration of a dimming control on the fixture's frame, 3) the optional integration of a backlit logo, and 4) the ability to control the amount and direction of light emitted above and under the luminaire.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A luminaire comprising a waveguide having at least one sidewall and two opposed planar surfaces, a frame secured to at least a segment of said sidewall, said frame including at least one light module configured to direct light into said waveguide, wherein at least one of said planar surfaces of said waveguide includes a light emitting region and a non-light emitting region between said frame and the light emitting region.

2. The luminaire of claim 1 wherein said non-light emitting region is opaque.

3. The luminaire of claim 1 wherein said non-light emitting region is translucent.

4. The luminaire of claim 1 wherein said non-light emitting region is transparent.

5. The luminaire of claim 1 wherein said frame is one of triangular, oval and rectangular.

6. The luminaire of claim 5 wherein said non-light emitting region is one of triangular, oval and rectangular.

7. The luminaire of claim 1 wherein said light module includes at least one light emitting diode.

8. The luminaire of claim 1 having a thickness less than about 50 mm.

9. The luminaire of claim 1 wherein said waveguide further comprises a additional non-light emitting region disposed within the light emitting region.

10. The luminaire of claim 9 wherein said additional non-light emitting region is one of opaque, translucent and transparent.

11. The luminaire of claim 9 wherein said additional non-light emitting region does not intersect said first non-light emitting region.

12. The luminaire of claim 9 wherein said additional non-light emitting region is in the shape of one of a logo, letters and numbers.

13. The luminaire of claim 7 further including at least one dimmer switch.

14. The luminaire of claim 1 further comprising one of suspension wires for securement to a ceiling and a bracket for mounting to one of a post and a wall.

15. A luminaire comprising a waveguide having at least three sidewalls and two opposed planar surfaces, a frame secured to said sidewalls, said frame including at least one light module configured to direct light into said waveguide, wherein at least one of said planar surfaces of said waveguide includes a light emitting region, and an at least substantially transparent non-light emitting region disposed between the frame and the light emitting region.

16. The luminaire of claim 15 having four sidewalls forming a rectangle.

17. The luminaire of claim 15 wherein light is emitted from only one of the opposed planar surfaces.

18. The lamination of claim 15 wherein said light module includes at least one LED.

19. A luminaire comprising a waveguide having a sidewall and at least one planar surface, a frame secured to said sidewall, said frame including at least one light module configured to direct light into said waveguide, wherein only said planar surface of said waveguide includes a light emitting region, said planar surface further including an at least substantially transparent non-light emitting region disposed between the frame and the light emitting region.

20. The luminaire of claim 19 wherein said waveguide and said frame are in the shape of a triangle, rectangle or oval.
